(19) United States
(12) Patent Application Publication
(10) Pub. No.: US 2010/0287253 A1
(43) Pub. Date: Nov. 11, 2010

(54) METHOD, APPARATUS, AND SYSTEM FOR DATA SYNCHRONIZATION

(75) Inventors: Lei XIE, Shenzhen (CN); Kepeng Li, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/839,822

(22) Filed: Jul. 20, 2010

Related U.S. Application Data
(63) Continuation of application No. PCT/CN2009/070117, filed on Jan. 13, 2009.

(30) Foreign Application Priority Data
Jan. 21, 2008 (CN) 200810004219.3

(51) Int. Cl. G06F 15/16

(52) U.S. Cl. 709/206

(57) ABSTRACT

A method for data synchronization includes: receiving a message comprising data synchronization parameters from a server; parsing the message to obtain the data synchronization parameters; and receiving data modification information, synchronizing the received data modification information according to a data filter rule carried in the data synchronization parameters. By using the method of the present invention, the client synchronizes the data according to the received data synchronization parameter. In the data synchronization process, the data synchronization parameters is easily set for the client, without manual operations, thus improving the operability of the data synchronization. An apparatus and system for data synchronization are also provided.

### CROSS-REFERENCE TO RELATED APPLICATIONS

This application is a continuation of International Application No. PCT/CN2009/070117, filed on Jan. 13, 2009, which claims priority to Chinese Patent Application No. 200810004219.3, filed on Jan. 21, 2008, both of which are hereby incorporated by reference in their entireties.

### FIELD OF THE INVENTION

The present invention relates to a data communications technology, and in particular, to a method, an apparatus, and a system for data synchronization.

### BACKGROUND OF THE INVENTION

With the progress of computer technologies and mobile communications technologies, the society has entered an information era. People need to exchange, transmit and store different types of information. In particular, with the popularity of mobile communications terminals, the users of the mobile communications terminals may receive and send information at any time and at any place. The users can process the information immediately, and store the processing results in the mobile communications terminals. In addition, the data in other data processing devices needs to be updated. The processing results are stored in other data processing devices to ensure the consistency of the data in all the devices.

In particular, with the development of telecom services, mobile networks and fixed networks are integrated, and interactions between the messaging services based on these two networks are enabled. Thus, the Open Mobile Alliance (OMA) formulates a new messaging service framework, that is, the IP-based Converged IP Messaging (CPM) service. The CPM service can provide users with experience of converged services, such as instant messaging, offline messaging, multimedia session, and video conference. The CPM service allows users to use communications services with different technical features on a unified basis, which overcomes the silos between non-CPM services due to technical differences. The CPM service supports interworking between IP-based messaging services and traditional messaging services, so that the users can enjoy the same service experience in all IP-based service domains according to a universal charging principle.

The CPM service provides the users with a multi-device application environment and a network-based data storage technology. It can synchronize the local storage of a terminal device with the network-based data storage over a related data synchronization protocol. Further, the CPM service enables data synchronization in the local storage between multiple devices of the same user. The data synchronization protocol may be the Synchronization Markup Language (SyncML) protocol or Internet Message Access Protocol (IMAP).

Because there are huge differences between user devices in functions, a user has different requirements for storing the same data in different devices. For example, in a personal computer (PC) of a user, the user may back up the network data completely, such as messages and multimedia files. In a personal digital assistant (PDA) with a small memory, the user hopes to reserve only some of the messages and multimedia files, and connects to the data in the network-based data storage through links. However, the setting for synchronizing data between multiple devices is complex over the data synchronization protocol in the prior art, thus affecting the user experience in data synchronization services.

### SUMMARY OF THE INVENTION

Embodiments of the present invention provide a method, an apparatus, and a system for data synchronization to overcome the problem in the prior art that a user must preset a data filter mechanism of a terminal device in a data synchronization service, thus simplifying the setting for the data synchronization and giving the user a better experience in the data synchronization service.

A method for data synchronization includes:

receiving, by a client, a message comprising data synchronization parameters from a server;

parsing, by a client, the message to obtain the data synchronization parameters; and

synchronizing, by the client, received data modification information according to filter parameters carried in the data synchronization parameters.

Another method for data synchronization includes:

sending, by a server, a message comprising data synchronization parameters to a client; and

sending, by a server, stored data to let the client synchronize the server stored data of the server according to filter parameters carried in the data synchronization parameters.

An apparatus for data synchronization includes:

a receiving unit, configured to receive a message comprising data synchronization parameters from a server;

a parsing unit, configured to parse the message received by the receiving unit to obtain the data synchronization parameters; and

a synchronizing unit, configured to synchronize received data modification information according to a data filter rule carried in the data synchronization parameters.

Another system for data synchronization includes:

a device management (DM) server, configured to send a message including data synchronization parameters to a client;

the client that includes a data synchronization management object (DSMO), where the DSMO stores the data synchronization parameters and is configured to: receive the message including the data synchronization parameters from the DM server, and synchronize stored data according to the filter parameters carried in the data synchronization parameters sent by the DM server; and

a SyncML server, configured to synchronize data with the client.

In embodiments of the present invention, data synchronization parameters of the client may be carried in a data synchronization notification message sent from the server or in a synchronization reply returned from the server; the client synchronizes data with the SyncML server according to the data synchronization parameters. In the data synchronization process, the data synchronization parameters is easily set for the client, without manual operations, thus improving the operability of the data synchronization.

### BRIEF DESCRIPTION OF THE DRAWINGS

FIG. 1 is a flowchart of a method for data synchronization in an embodiment of the present invention;

FIG. 2 is a flowchart in an embodiment of the present invention;

FIG. 3 shows a structure of an extended data synchronization message in an embodiment of the present invention;

FIG. 4 shows a structure of device information in an embodiment of the present invention;

FIG. 5 is a flowchart in another embodiment of the present invention;

FIG. 6 shows a structure of an apparatus for data synchronization in an embodiment of the present invention;

FIG. 7 shows a structure of Embodiment 1 of a system; and

FIG. 8 shows a structure of Embodiment 2 of the system.

### DETAILED DESCRIPTION OF THE EMBODIMENTS

The following describes the present invention in detail with reference to the accompanying drawings and exemplary embodiments. In the embodiments of the present invention, a user has two CPM terminals, that is, a PC and a PDA, and data synchronization is performed between one of the two terminals and the SyncML server. For example, the PC is configured to back up all the e-mails on the SyncML server. Thus, it is necessary to set the PC to completely synchronize the data with the SyncML server. However, due to the limited memory of the PDA, it is necessary to set the PDA to store only some of the information, such as subjects and senders of the e-mails.

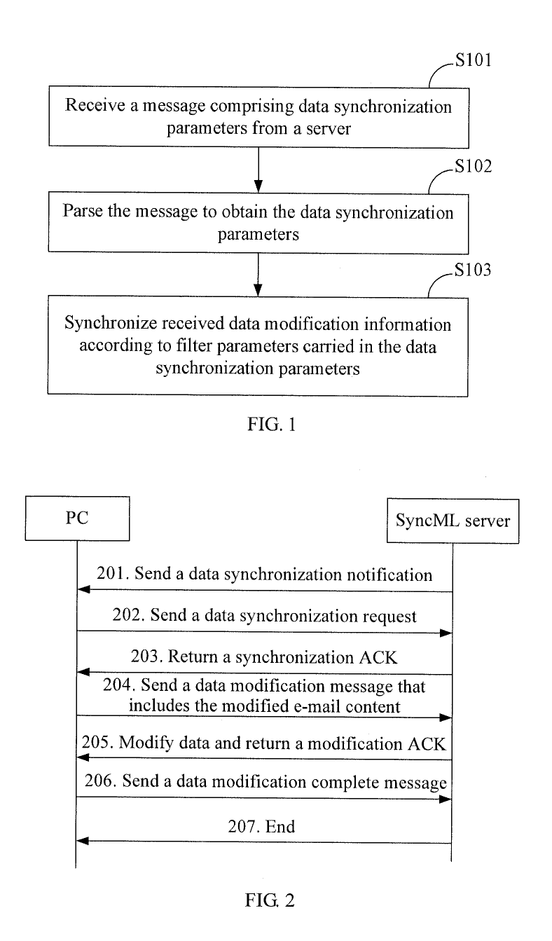

As shown in FIG. 1, the method provided in an embodiment of the present invention includes the following steps:

Step S101: A client receives a message including data synchronization parameters from a server.

Step S102: A client parses the message to obtain the data synchronization parameters.

Step S103: A client synchronizes the data modification information according to filter parameters carried in the data synchronization parameters.

According to the method for data synchronization, the user presets the data synchronization parameters of the PC on the SyncML server; if the content of an e-mail in the PC is changed, the data synchronization process between the PC and the SyncML server is shown in FIG. 2 and includes the following steps:

Step 201: The SyncML server sends a data synchronization notification that includes the data synchronization parameters of the PC to the PC.

In the data synchronization process in this embodiment, the data synchronization notification sent to the PC is enhanced. Table 1 lists the typical structure of a SyncML message.

TABLE 1
<< Data (i.e. notification) pushed from the server >>

| | | |
|---|---|---|
| XX, XX, XX, XX, XX, XX, | 128-bit digest value | MD5 Digest |
| | | authentication value |
| XX, XX, XX, XX, XX, XX, | | |
| XX, XX, XX, XX | | |

Notification Header >>

| | | |
|---|---|---|
| 03, 18, 00, 00, 00 | Binary ‘0000001100’ | Version ‘1.2’ |
| | Binary ‘01’ = Background mode | UI-Mode ‘1’ |
| | Binary ‘1’ = Server Initiated Action | Initiator ‘1’ |
| | Binary | Future use |
| | ‘000000000000000000000000000’ | |
| 00, 01 | Binary ‘0000000000000001’ | SessionID ‘1’ |
| 0F | Binary ‘00001111’ | Server Identifier |
| | | length ‘15’ |
| 73, 79, 6E, 63, 2E, 73, 65, | String ‘sync.server.com’ | Server Identifier |
| 72, 76, 65, 72, 2E, 63, 6F, | | |
| 6D | | |

Notification Body >>

| | | |
|---|---|---|
| 10 | Binary ‘0001’ | Number of syncs. |
| | | One Sync Info |
| | | container included |
| | Binary ‘0000’ | Future use |

Sync info >>

| | | |
|---|---|---|
| 60 | Binary ‘0110’ | Sync type ‘206’ |
| | Binary ‘0000’ | Future use |
| 00, 00, 07 | Binary | Content-type |
| | ‘000000000000000000000111’ | ‘text/x-vcard’ |
| 04 | Binary ‘00000100’ | Server URI length ‘4’ |
| 2F, 63, 6F, 6E | String ‘/con’ | The name of server |
| | | data store |
| | | [Server URI] |

Optional Vendor specific info >> (Binary n*BIT)

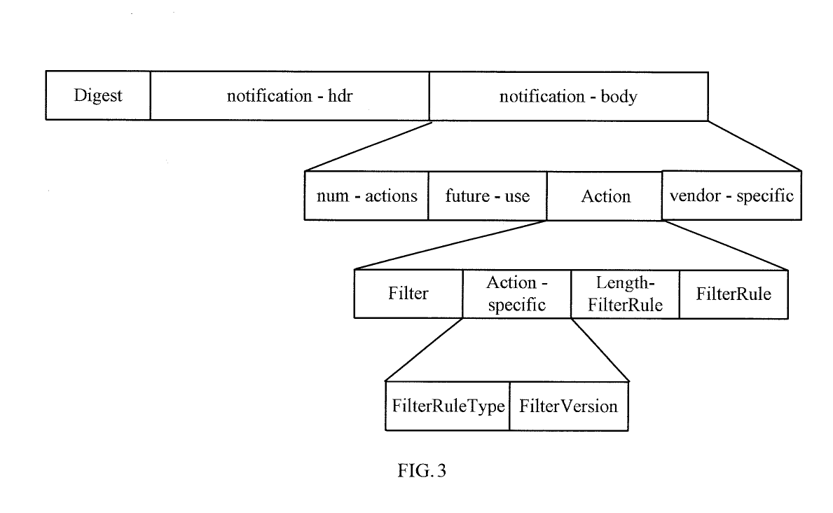

In this embodiment, the notification body or the Sync info body in the structure of the SyncML message is extended. The method for extending the notification body is shown in FIG. 3. Multiple Actions may be carried in the notification body, with each Action configured to set the necessary information of the synchronization session, for example, the database that stores the data to be synchronized and the synchronization type.

In this embodiment, an Action is extended to set the filter parameters of the synchronization session. Specifically, the filter field in the Action is used to represent the filter function of the Action.

In addition, the FilterRuleType field in the Action is used to set the syntax of the filter rule, that is, the syntax information. Different numbers may be used to represent different syntax types. For example, 0 represents the CGI syntax, and 1 represents the SQL syntax.

The FilterVersion field is used to represent the syntax version of the filter rule, which may also be represented by numbers.

The FilterRule field represents the specific filter rule.

The Length-FilterRule field represents the specific length of the FilterRule field, which facilitates the client to parse the notification message.

Step 202: The PC parses the synchronization notification, and knows that complete data synchronization needs to be performed with the SyncML server according to the parsed data synchronization parameter. Then, the PC sends a data synchronization request to the SyncML server, requesting synchronization of data with the SyncML server.

Step 203: The SyncML server accepts the data synchronization request, and returns a synchronization ACK (acknowledgement) to the PC.

Step 204: The PC sends a data modification message that includes the modified e-mail content to the SyncML server according to the synchronization ACK.

In this step, the PC sends the locally modified data information to the SyncML server. Thus, the PC does not use the filter rule.

Step 205: The SyncML server receives the message from the PC, modifies the content of the local e-mail to synchronize the data with the PC, and returns a modification ACK to the PC.

The modification ACK sent to the PC includes not only the receipt ACK that the SyncML server returns after receiving the data modification message including the modified e-mail content but also the modification information of the local data.

In this embodiment, the SyncML server does not modify the local data. Thus, the data modification information sent in this step is empty, indicating that the data is not modified. If the SyncML server modifies the local data, the PC filters the data modification information according to the filter rule in the received data synchronization parameter. For example, if the time of sending an e-mail is changed but needs to be filtered in the filter rule, the PC does not modify the local data.

Step 206: The PC receives the receipt ACK and the empty data modification information, and sends a data modification complete message to the SyncML server.

Step 207: The SyncML server receives the data modification complete message. Then, the data synchronization process ends.

In this embodiment, the SyncML server sends a data synchronization notification that includes the data synchronization parameters of the PC to the PC; the data synchronization is performed between the SyncML server and the PC according to the data synchronization process. In this data synchronization process, the data synchronization parameters are easily set for the PC, without manually configuring the data synchronization parameters for the client, thus improving the operability of the data synchronization.

In this embodiment, by using the technical solution of extending the SyncML message between the SyncML server and the PC, the data synchronization parameters of the PC is carried in the message body of the SyncML message or synchronization markup information. The technical solution is applicable to this embodiment and other embodiments of the present invention.

In another embodiment of the present invention, the user presets data synchronization parameters of the PDA on the SyncML server. For example, the parameter requires the PDA to store the subject, sender and generation time of an e-mail. If the generation time of an e-mail on the SyncML server is changed, the data synchronization process between the PDA and the SyncML server is shown in FIG. 5 and includes the following steps:

Step 501: The PDA sends a data synchronization request to the SyncML server.

Step 502: The SyncML server accepts the data synchronization request from the PDA, and returns a synchronization ACK to the PDA.

The synchronization ACK includes the data synchronization parameters of the PDA. In this embodiment, the filter rule in the data synchronization parameters indicates the subject, sender, and generation time of the e-mail.

Step 503: The PDA receives the synchronization ACK, parses the synchronization ACK to obtain the data synchronization parameters, and sends a data modification message to the SyncML server according to the data synchronization parameters.

In this embodiment, the PDA does not modify the local data. Thus, the data modification information sent in the message is empty.

Step 504: The SyncML server receives the data modification information of the PDA, and returns a modification ACK that includes the data modification information of the SyncML server.

Step 505: The PDA receives the modification ACK, obtains the changes in the subject, sender, and generation time of the e-mail according to the filter rule, modifies the local e-mail data, and returns a data modification complete message.

In this step, the PDA selects data that complies with the filter rule for synchronization according to the data filter rule.

Step 506: The SyncML server receives the data modification complete message. Then, the data synchronization process ends.

In this embodiment, the SyncML server sends a data synchronization ACK that includes the data synchronization parameters of the PDA to the PDA; the data synchronization is performed between the SyncML server and the PDA according to the data synchronization process. In this data synchronization process, the data synchronization parameters are easily set for the PDA, without manually configuring the data synchronization parameters for the client, thus improving the operability of the data synchronization.

In this embodiment, the data that needs to be synchronized may be the phone address book, schedule, e-mail, file, file folder, CPM data or converged address book (CAB).

In the preceding two embodiments, the SyncML server sends data synchronization parameters to the client, so that the client obtains the filter rule in the case of data synchronization. In addition, the data synchronization parameters may be stored in a DSMO. The DSMO is set on the client. Before the data synchronization process between the client and the SyncML server, the DM server may send data synchronization parameters to the client or update the data synchronization parameters on the client at its own discretion or according to requests of other entities. After obtaining the data synchronization parameters, the client synchronizes the data with the SyncML server.

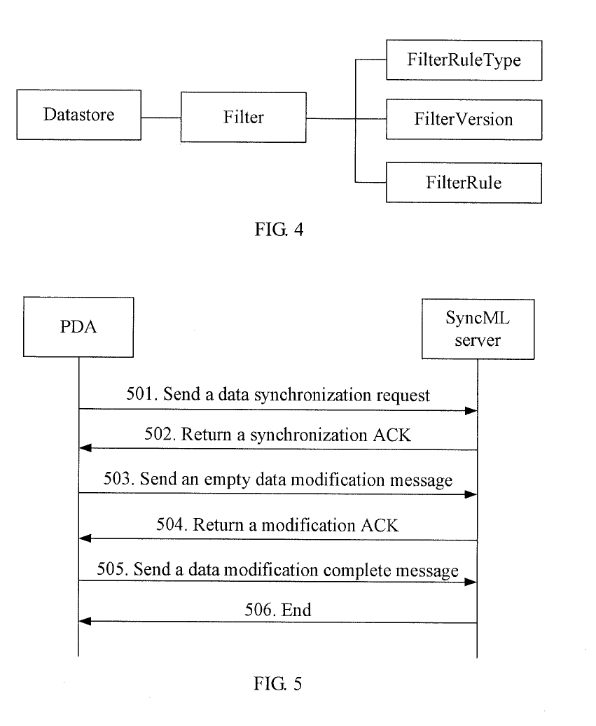

In addition, the filter rule of the data synchronization parameters may be stored in the device information (DevInf) of the client or the SyncML server. The PC and the SyncML server may obtain the data filter parameter of each other by exchanging respective DevInf or replace the original data filter rule of each other by using the Replace command. FIG. 4 shows the structure of the DevInf. In FIG. 4, FilterRuleType represents the syntax of the filter rule, FilterVersion represents the syntax version of the filter rule, and FilterRule represents the specific filter rule.

In embodiments of the present invention, the data synchronization parameters of the client may be carried in a data synchronization notification message sent from the server or in a synchronization reply returned from the server; the client synchronizes the data with the SyncML server according to the data synchronization parameters. In the data synchronization process, the data synchronization parameters are easily set for the client, without manual operations, thus improving the operability of the data synchronization. Although the data synchronization may be selectively performed over the data synchronization protocol in the prior art by using the filter rule based on the data item property and data field value, the user must perform configurations on the client in advance. In a multi-device application environment, the user needs to perform data filter setting for each device, thus making the setting for data synchronization between multiple devices more complex and affecting the user experience in data synchronization services.

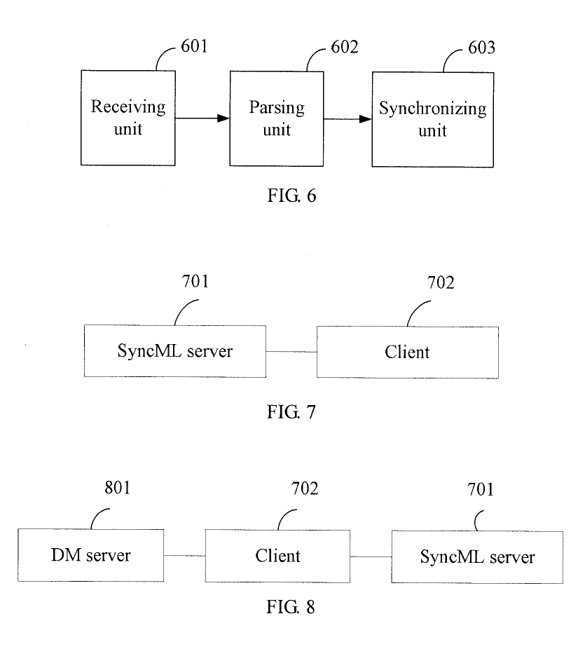

As shown in FIG. 6, an apparatus provided in an embodiment of the present invention includes:

a receiving unit 601, configured to receive a message comprising data synchronization parameters from a server;

a parsing unit 602, configured to parse the message received by the receiving unit to obtain the data synchronization parameters; and

a synchronizing unit 603, configured to synchronize received data modification information according to a data filter rule carried in the data synchronization parameters.

In another embodiment, the PC client includes the apparatus for data synchronization; the user presets the data synchronization parameters of the PC on the SyncML server; if the content of an e-mail in the PC is changed, the data synchronization process between the PC and the SyncML server includes the following steps:

1. The receiving unit 601 receives a data synchronization notification that includes the data synchronization parameters of the PC from the SyncML server.

2. The parsing unit 602 parses the received data synchronization notification to obtain the data synchronization parameters. If knowing that complete data synchronization needs to be performed with the SyncML server, the synchronizing unit 603 sends a data synchronization request to the SyncML server, requesting data synchronization with the SyncML server.

3. The SyncML server accepts the data synchronization request, and returns a synchronization ACK to the PC.

4. The PC sends a message that includes the modified e-mail content to the SyncML server according to the synchronization ACK.

5. The SyncML server receives the message from the PC, modifies the content of the local e-mail according to the modified e-mail content to synchronize the e-mail data with the PC, and returns an ACK to the PC.

The ACK sent to the PC includes not only the receipt ACK that the SyncML server returns after receiving the message including the modified e-mail content but also the modification information of the local data.

In addition, in this embodiment, the SyncML server does not modify the local data. Thus, the data modification information in this step is empty, indicating that the data is not modified.

6. The PC receives the receipt ACK and empty data modification information, and sends a data modification complete message to the SyncML server. The SyncML server receives the data modification complete message. Then, the data synchronization process ends.

In the preceding process, because the data modification information that the SyncML server sends to the PC is empty, the PC does not need to perform synchronization by using the synchronizing unit 603.

In another embodiment of the present invention, the PDA client includes the apparatus for data synchronization; the user presets the data synchronization parameters of the PDA on the SyncML server. For example, the parameter requires the PDA to store the subject, sender and generation time of an e-mail. If the generation time of an e-mail on the SyncML server is changed, the data synchronization process between the PDA and the SyncML server includes the following steps:

1. The PDA sends a data synchronization request to the SyncML server.

2. The SyncML server accepts the data synchronization request from the PDA, and returns a synchronization ACK to the PDA. The synchronization ACK includes the data synchronization parameters of the PDA.

3. The receiving unit 601 of the PDA receives the synchronization ACK. The parsing unit 602 parses the synchronization ACK to obtain the data synchronization parameters of the PDA.

4. The PDA sends data modification information to the SyncML server according to the obtained data synchronization parameter.

In this embodiment, the PDA does not modify the local data. Thus, the data modification information is null.

5. The SyncML server receives the data modification information of the PDA, and returns an ACK that includes the data modification information of the SyncML server.

6. The PDA receives the ACK. The synchronizing unit of the PDA obtains the changes in the subject, sender, and generation time of the e-mail according to the filter rule carried in the data synchronization parameters, modifies the local e-mail data, and returns a data modification complete message.

7. The SyncML server receives the data modification complete message. Then, the data synchronization process ends.

In the preceding embodiments, the SyncML server sends a data synchronization ACK that includes the data synchronization parameters of the client (PC or PDA) to the client; the data synchronization is performed between the SyncML server and the client according to the data synchronization process. In this data synchronization process, the data synchronization parameters are easily set for the client, without manual operations, thus improving the operability of the data synchronization.

Further, during the implementation of the technical solution of the present invention, the data synchronization parameters may also be stored in a DSMO. Before the execution of the data synchronization process between the client and the SyncML server, the DM server may send data synchronization parameters to the client at its own discretion or according to the requests of other entities.

An embodiment of the present invention also provides a system for data synchronization.

FIG. 7 shows a structure of Embodiment 1 of the system.

The system for data synchronization includes:

a SyncML server 701, configured to: send a message including data synchronization parameters to a client 702, and synchronize data with the client; and

the client 702, configured to: receive the message including the data synchronization parameters, and synchronize received data modification information according to a data filter rule carried in the received data synchronization parameter.

FIG. 8 shows a structure of Embodiment 2 of the system.

Another system for data synchronization includes:

a DM server 801, configured to send a message including data synchronization parameters to a client 702;

the client 702 that includes a DSMO, where the DSMO stores the data synchronization parameters and is configured to: receive the message including the data synchronization parameters from the DM server 801, and synchronize the received data modification information according to a data filter rule carried in the data synchronization parameters sent from the DM server 801; and

a SyncML server 701, configured to synchronize data with the client.

In this embodiment, the data synchronization parameters are stored in the DMSO of the client. Before the execution of the data synchronization process between the client and the SyncML server, the DM server may send data synchronization parameters to the client or update the data synchronization parameters on the client at its own discretion or according to the requests of other entities. After obtaining the data synchronization parameters, the client synchronizes data with the SyncML server.

It should be noted that the filter parameters include the data filter rule. The data filter rule includes the type, content, version, and length of the filter rule.

In addition, the SyncML protocol is used in embodiments of the present invention. In specific data synchronization applications, different data synchronization protocols may be used to perform the data synchronization between the client and the SyncML server. The data synchronization protocol is not limited to the SyncML protocol or the IMAP protocol.

In addition, in embodiments of the present invention, the CPM message and the CAB can be transmitted over the data synchronization protocol.

It should be noted that the data to be synchronized may be the phone address book, schedule, e-mail, file, file folder, CPM data or CAB.

It is understandable by those skilled in the part that all or a part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be any medium that is capable of storing program codes, such as a read-only memory (ROM), a random access memory (RAM), a magnetic disk, or a compact disk read-only memory (CD-ROM).

In addition, the functional units in each embodiment of the present invention may be integrated in one processing module, or each unit exists separately, or two or more units are integrated in one processing module. The integrated module may be embodied in the form of hardware or a software functional module. If the integrated module is embodied in the form of a software functional module and is sold or used as a separate product, the integrated module may be stored in a computer readable storage medium. The storage medium may be a ROM, a magnetic disk, or a CD-ROM.

It should be noted that the above descriptions are merely preferred embodiments of the present invention, and those skilled in the art may make various improvements and refinements without departing from the spirit of the invention. All such modifications and refinements are intended to be covered by the present invention.

What is claimed is:

1. A method for data synchronization, comprising:
receiving, by a client, a message comprising data synchronization parameters from a server;
parsing, by the client, the message to obtain the data synchronization parameters; and
synchronizing, by the client, received data modification information according to filter parameters carried in the data synchronization parameters.

2. The method of claim 1, wherein the filter parameters comprise a data filter rule.

3. The method of claim 1, wherein the filter parameters comprise a type, content, version, and length of a data filter rule.

4. The method of claim 1, wherein the receiving, by a client, a message comprising data synchronization parameters from a server comprises:
receiving, by the client, the message comprising the data synchronization parameters from a device management (DM) server.

5. The method of claim 4, wherein after the receiving, by a client, the message comprising the data synchronization parameters from the DM server, the method further comprises: storing or updating a data synchronization management object (DSMO) of a client based on the data synchronization parameters.

6. The method of claim 1, wherein the receiving, by a client, a message comprising the data synchronization parameters from a server comprises:
receiving, by the client, a data synchronization notification message comprising the data synchronization parameters from a SyncML server.

7. The method of claim 1, wherein the receiving, by a client, a message comprising the data synchronization parameters from a server comprises:
receiving, by the client, a data synchronization session message comprising the data synchronization parameters from the server.

8. The method of claims 2, wherein the synchronizing, by the client, received data modification information according to filter parameters carried in the data synchronization parameters comprises:
selecting, by the client, the received data modification information that complies with the data filter rule for synchronization according to the data filter rule and synchronizing the selected data modification information.

9. The method of claims 1, wherein the synchronizing, by the client, received data modification information according to filter parameters carried in the data synchronization parameters further comprises:
sending, by the client, locally modified data information to let the server synchronize the locally modified data information of the client, wherein if the client does not modify its local data, the locally modified data information is empty.

10. The method of claim 1, wherein
the receiving, by a client, a message comprising data synchronization parameters from a server comprises:
receiving, by a client, a data synchronization notification message comprising data synchronization parameters from a server;
after the parsing, by the client, the message to obtain the data synchronization parameters, the method further comprises:
sending, by the client, a data synchronization request to the server; and
receiving, by the client, a data synchronization ACK from the server;
the synchronizing, by the client, received data modification information according to filter parameters carried in the data synchronization parameters comprises:
sending, by the client, locally modified data information to let the server synchronize the stored data of the client, wherein if the client does not modify its local data, the locally modified data information is empty.

11. A method for data synchronization, comprising:
sending, by a server, a message comprising data synchronization parameters to a client; and
sending, by the server, locally modified data information to let the client synchronize the stored data of the server according to filter parameters carried in the data synchronization parameters.

12. The method of claim 11, wherein the filter parameters comprise a data filter rule.

13. The method of claim 11, wherein the filter parameters comprise a type, content, version, and length of the data filter rule.

14. The method of claim 11, wherein the sending, by a server, a message comprising data synchronization parameters to a client comprises:
sending, by a device management (DM) server, a message comprising data synchronization parameters to the client.

15. The method of claim 11, wherein the sending, by a server, a message comprising data synchronization parameters to a client comprises:
sending, by the server, a data synchronization session message comprising data synchronization parameters to the client.

16. The method of claim 11, wherein after the sending, by a server, a message comprising data synchronization parameters to a client, the method further comprises:
receiving, by the server, a data synchronization request from the client; and
sending, by the server, a data synchronization ACK to the client.

17. The method of claims 11, further comprising:
receiving, by the server, locally modified data information from the client; and
synchronizing, by the server, locally modified data information of the client base on the locally modified data information from the client.

18. An apparatus for data synchronization, comprising:
a receiving unit, configured to receive a message comprising data synchronization parameters from a server;
a parsing unit, configured to parse the message received by the receiving unit to obtain the data synchronization parameters; and
a synchronizing unit, configured to synchronize received data modification information according to a data filter rule carried in the data synchronization parameters.

19. The apparatus of claim 18, further comprising: a selecting unit, configured to select the data modification information that complies with the data filter rule for synchronization according to the data filter rule and synchronizing the selected data modification information.

20. A system for data synchronization, comprising a device management (DM) server, a client, and a SyncML server, wherein:
the DM server is configured to send a message comprising data synchronization parameters to the client;
the client comprises a data synchronization management object (DSMO), wherein the DSMO stores the data synchronization parameters and is configured to: receive the message comprising the data synchronization parameters from the DM server, and synchronize stored data according to filter parameters carried in the data synchronization parameters sent by the DM server; and
the SyncML server is configured to synchronize data with the client.
